(19) United States
(12) Patent Application Publication
(10) Pub. No.: US 2019/0176311 A1
(43) Pub. Date: Jun. 13, 2019

(54) NAILING DEVICE AND ADJUSTABLE NAILING DEPTH MODULE THEREOF

(71) Applicant: BASSO INDUSTRY CORP., Taichung (TW)

(72) Inventors: Guey-Horng LIOU, Taichung (TW); Fu-Ying HUANG, Taichung (TW); Wen-Cheng LO, Taichung (TW)

(21) Appl. No.: 16/211,408

(22) Filed: Dec. 6, 2018

(30) Foreign Application Priority Data
Dec. 7, 2017 (TW) 106218177

(51) Int. Cl. B25C 1/00

(52) U.S. Cl. CPC B25C 1/008

(57) ABSTRACT

Disclosed are a nailing device and an adjustable nailing depth module used in a gun body of the nailing device. The gun body has a muzzle and a safety device capable of moving reciprocally with respect to the muzzle. The adjustable nailing depth module includes a fixed rod and an adjusting shaft. The fixed rod and muzzle are parallelly fixed to the gun body and extended to a length. The fixed rod has an end section away from the gun body. The adjusting shaft and the end section of the fixed rod are coupled to each other by a screw structure. The adjusting shaft is corresponsive to the safety device. The adjusting shaft can move away from or close to the safety device by the screw structure. The safety device is blocked by the adjusting shaft to restrict the distance of pressing the safety device downwardly towards the muzzle.

### FIELD OF THE INVENTION

The technical field of this disclosure relates to a nailing device, and more particularly to a nailing device and its adjustable nailing depth module.

### BACKGROUND OF THE INVENTION

In general, a conventional nail gun has a safety lock installed at a muzzle of the nail gun, a safety plate linked with the safety lock, and an adjusting mechanism provided for moving the safety lock back and forth. When the position of the safety lock is adjusted by the adjusting mechanism, the safety lock abuts against a surface of a workpiece. After the safety lock is pressed and a trigger mechanism of the nail gun is pulled, the safety plate is linked to hit the trigger mechanism, so that a cylinder in the nail gun is actuated to strike a nail. The safety lock can be driven to move forward or backward by rotating the adjusting mechanism, so as to change the distance between the muzzle and the surface of the workpiece by the operation of the nail gun and achieve the effect of adjusting the nailing depth of the nail gun.

However, most of the adjusting mechanisms of the conventional nail gun are hidden between the muzzle and the safety lock by a cover, so that it is necessary to lift the cover to expose and rotate the adjusting mechanism. In addition, the components of the adjusting mechanism are too complicated and thus making the assembling process difficult and incurring high costs and inconvenient maintenance. Therefore, it is a main subject for the nail gun related industry to improve over the conventional nail gun by providing a convenient and simple-structured adjusting mechanism.

In view of the aforementioned drawbacks of the conventional nail gun, the discloser of this disclosure based on years of experience in the related industry to conduct extensive research and experiment, and finally developed an innovative nailing device and its adjustable nailing depth module to overcome the drawback of the prior art.

### SUMMARY OF THE INVENTION

Therefore, it is a primary objective of this disclosure to overcome the drawbacks of the prior art by providing a nailing device and its adjustable nailing depth module, wherein a safety device will be blocked and limited by an adjusting shaft when the safety device abuts the adjusting shaft while the safety device is being restricted from moving close to the muzzle, so as to limit the distance between the safety device and the muzzle and achieve the effect of adjusting the nailing depth of the nailing device.

In an exemplary embodiment of this disclosure, this disclosure provides a nailing device comprising: a gun body including a muzzle and a trigger; a safety device installed on a side of the muzzle and capable of moving with respect to the muzzle, and an end of the safety device being near the trigger for driving the trigger, and the other end of the safety device having a contact and a transmission rod extending in a direction from the contact towards the gun body and parallel to the muzzle; and an adjustable nailing depth module further comprising: a fixed rod, together with the muzzle parallelly fixed to the gun body and extending to a length, and the fixed rod having an end section disposed at a position away from the gun body; and an adjusting shaft, coupled to the end section of the fixed rod by a screw structure, and configured to be opposite to the transmission rod; wherein the adjusting shaft is capable of moving close to or away from the transmission rod by using the screw structure, and the safety device is blocked by the transmission rod and the adjusting shaft to restrict the distance of pressing the safety device downwardly towards the muzzle.

In an exemplary embodiment of this disclosure, this disclosure provides an adjustable nailing depth module used in a gun body, and the gun body has a muzzle and a safety device capable of moving reciprocally with respect to the muzzle, and the adjustable nailing depth module comprises: a fixed rod with the muzzle parallelly fixed to the gun body and extended to a length, and the fixed rod having an end section disposed away from the gun body; and an adjusting shaft, coupled to the end section of the fixed rod by a screw structure, and configured to be corresponsive to the safety device; wherein, the adjusting shaft is capable of moving away from or close to the safety device by the screw structure, and the safety device is blocked by the adjusting shaft to restrict the distance of pressing the safety device downwardly towards the muzzle.

Wherein, the ball is accommodated in the ball pocket and embedded into the limit slot. When the adjusting shaft rotates with respect to the fixed rod, and the ball is configured to be corresponsive to the limit slot, the ball will roll into the limit slot and be embedded into the limit slot, so as to achieve the effect of positioning the adjusting shaft.

Wherein, the adjustable nailing depth module achieves the effect of adjusting the nailing depth of the nailing device by means of the simple components and their structural assembly of the safety device, fixed rod and adjusting shaft. In addition, the adjustable nailing depth module has the advantages of simple components, easy assembling, convenient operation, and low cost.

### BRIEF DESCRIPTION OF THE DRAWINGS

FIG. 1 is a perspective view of a nailing device of this disclosure;

FIG. 2 is a perspective view of an adjustable nailing depth module of this disclosure;

FIG. 3 is an exploded view of an adjustable nailing depth module of this disclosure;

FIG. 4 is a schematic view of using an adjustable nailing depth module of this disclosure;

FIG. 5 is a schematic view showing a first using status of a nailing device in accordance with this disclosure;

FIG. 6 is a schematic view showing a second using status of a nailing device in accordance with this disclosure; and

FIG. 7 is a schematic view showing a third using status of a nailing device in accordance with this disclosure.

### DESCRIPTION OF THE PREFERRED EMBODIMENTS

The technical contents of this disclosure will become apparent with the detailed description of preferred embodiments accompanied with the illustration of related drawings as follows. It is noteworthy that same numerals are used for representing same respective elements in the drawings.

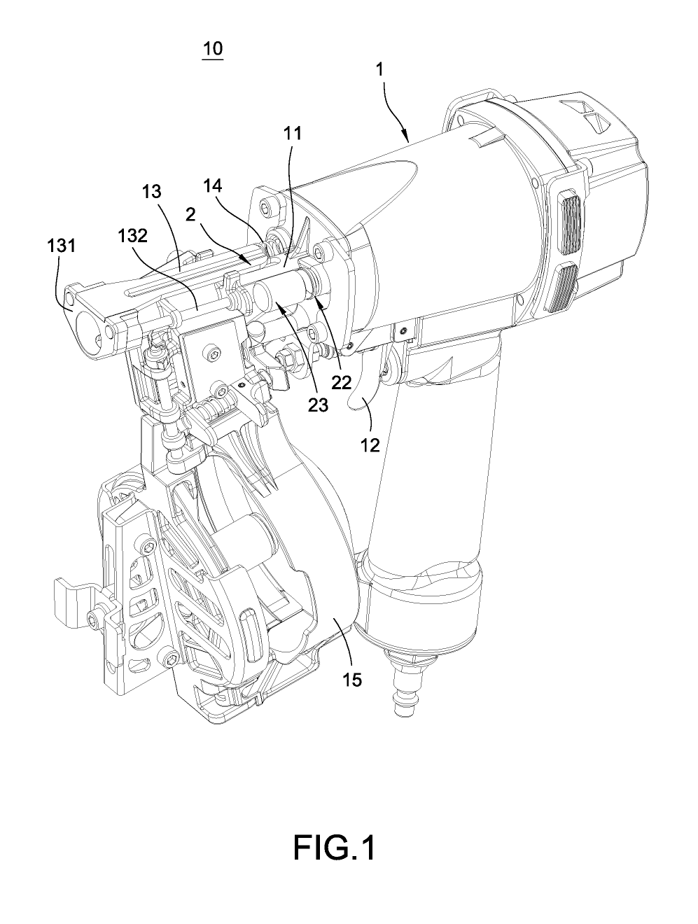

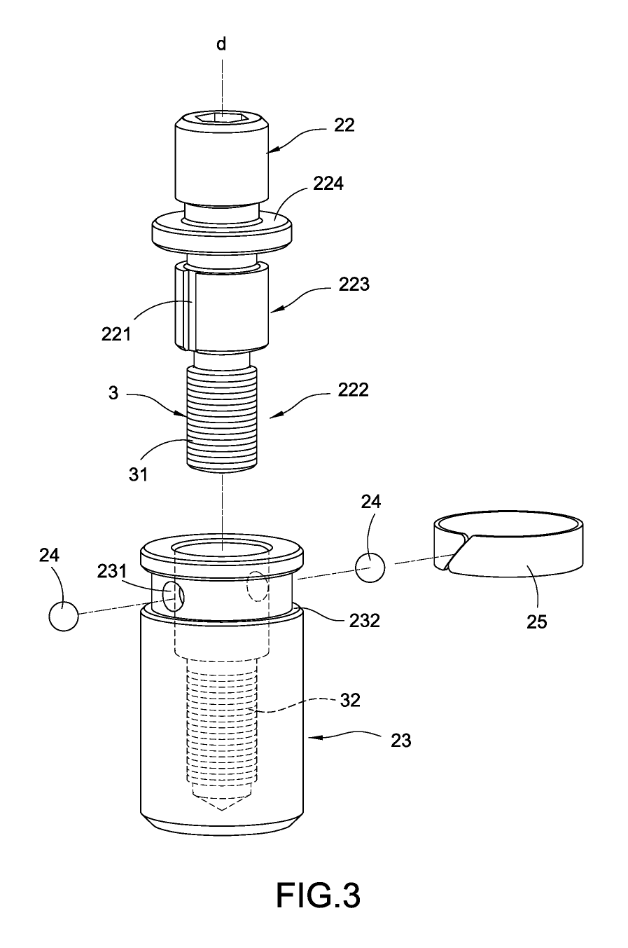

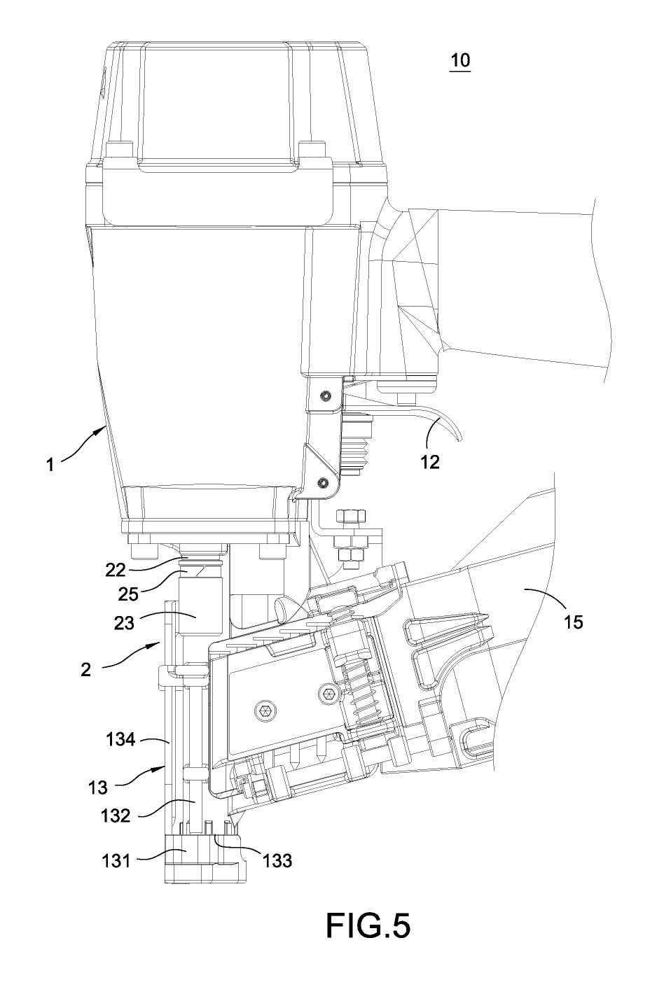

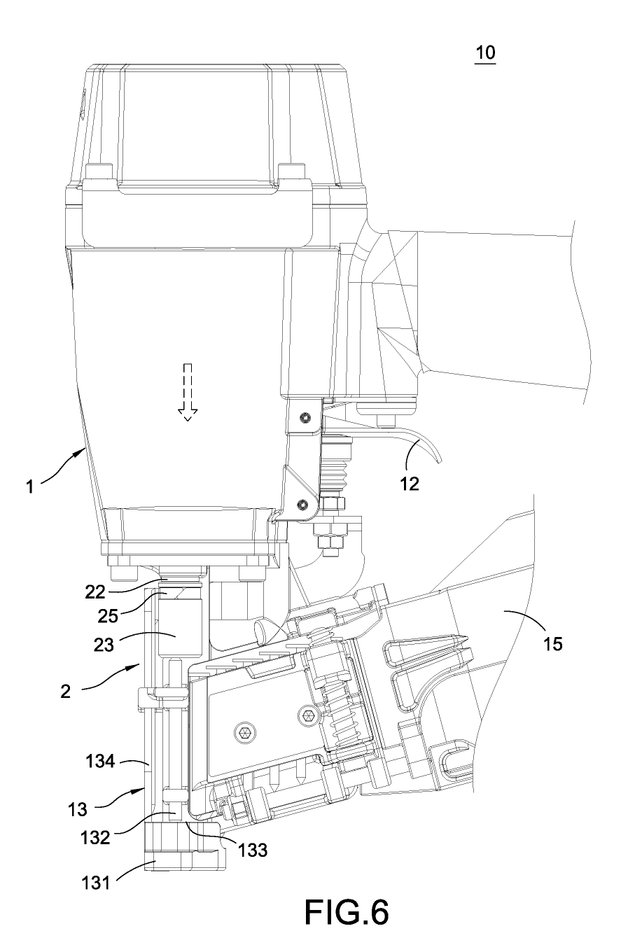

With reference to FIGS. 1 to 7 for a nailing device and its adjustable nailing depth module in accordance with this disclosure, the nailing device 10 comprises a gun body 1, a safety device 13 and an adjustable nailing depth module 2; and the adjustable nailing depth module 2 comprises a fixed rod 22 and an adjusting shaft 23.

In FIGS. 1, and 5 to 7, the gun body 1 has a muzzle 11 and a trigger 12, and the safety device 13 is installed on a side of the muzzle 11 and capable of moving reciprocally with respect to the muzzle 11, and a restoring spring 14 is installed between the gun body 1 and the safety device 13, and an end of the safety device 13 is installed at a position near the trigger 12 for driving the trigger 12, and the other end of the safety device 13 has a contact 131 and a transmission rod 132 extended from the contact 131 in a direction towards the gun body 1 and substantially parallel to the muzzle 11, and the safety device 13 has a front end 133, and the contact 131 is fixed to front end 133.

Wherein, the movement of the safety device 13 is described below. When a pressure is exerted onto the contact 131 of the safety device 13, the restoring spring 14 will be compressed to move towards the muzzle 11. When the pressure exerted onto the contact 131 is released, the restoring spring 14 will also be released, and thus the contact 131 will be moved in a direction away from the muzzle 11.

In addition, the gun body 1 further has a nail gun magazine 15 coupled and communicated to the muzzle 11, and the nail gun magazine 15 is provided for feeding nails to the muzzle 11, and the trigger 12 is provided for a user to press, so that the trigger 12 and the components in the gun body 1 automatically drive the nail to be struck out from the muzzle 11.

In FIGS. 1 to 7, the adjustable nailing depth module 2 comprises a fixed rod 22, an adjusting shaft 23 and one or more balls 24. The fixed rod 22 and the muzzle 11 are parallelly fixed to the gun body 1 and extended to a length, and the fixed rod 22 has an axial line d and one or more limit slots 221 formed in along the axial line d, and the fixed rod 22 has an end section 222 situation at a position away from the gun body 1 and a middle section 223, and the limit slot 221 is formed in the middle section 223 and the fixed rod 22 has extended from a position between the gun body 1 and the middle section 223.

In FIGS. 1 to 7, the adjusting shaft 23 is installed between the fixed rod 22 and the transmission rod 132, and the adjusting shaft 23 and the end section 222 of the fixed rod 22 are coupled to each other by a screw structure 3, and the adjusting shaft 23 is configured to be opposite to the transmission rod 132, and the adjusting shaft 23 can be blocked by the blocking ring 224, and the adjusting shaft 23 has one or more balls pocket 231 and a recessed ring groove 232, and the ball pocket 231 penetrates from a bottom wall of the recessed ring groove 232 to an inner wall of the adjusting shaft 23.

Wherein, the adjusting shaft 23 can restrict the distance of pressing the safety device 13 downwardly towards the muzzle 11 by moving the screw structure 3 away from or close to the transmission rod 132 when the safety device 13 are blocked and limited by the transmission rod 132 and the adjusting shaft 23.

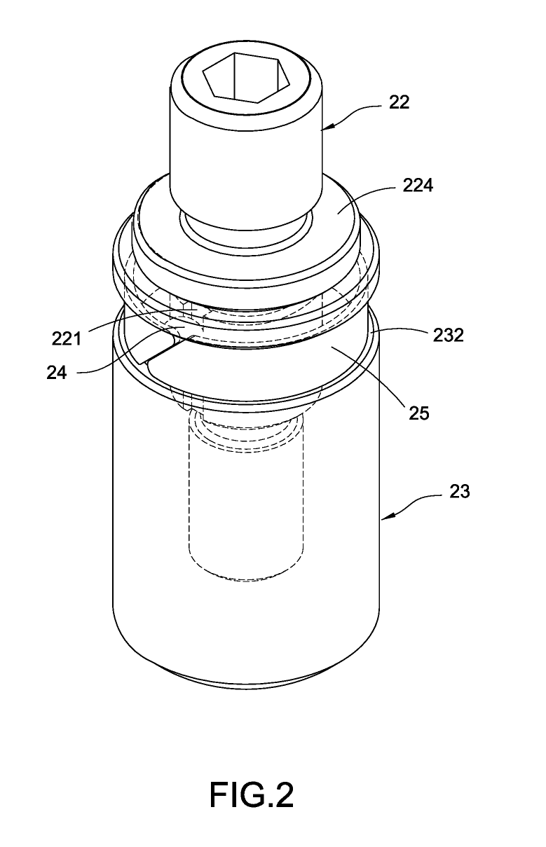

In FIGS. 2 to 4, the screw structure 3 includes an external thread 31 formed at the outside of the end section 222 of the fixed rod 22 and an internal thread 32 formed at the inside of the adjusting shaft 23, and the external thread 31 and the internal thread 32 are screwed and coupled to each other.

In FIGS. 2 to 4, the ball 24 is accommodated in the ball pocket 231 and embedded into the limit slot 221, so that the adjusting shaft 23 can be rotated with respect to the fixed rod 22, and when the ball 24 is corresponsive to the limit slot 221, the ball 24 will roll into the limit slot 221 and be embedded in with the limit slot 221 to achieve the effect of positioning the adjusting shaft 23.

In FIGS. 2 to 7, the adjustable nailing depth module 2 further comprises a collar 25 sheathed on and received by the recessed ring groove 232, and the ball 24 is clamped between the collar 25 and the fixed rod 22, so that the ball 24 is limited securely in the ball pocket 231.

With reference to FIGS. 1 to 7 for the using status of the nailing device 10 and the adjustable nailing depth module 2 in accordance with this disclosure, the contact 131 at the front end 133 of the safety device 13 is provided for abutting a surface of a workpiece and pressed, and the trigger 12 is pressed, and the trigger 12 and internal components of the gun body 1 are linked to drive the nail to be stuck out from the muzzle 11. After the adjusting shaft 23 is adjusted by the screw structure 3 to move away from or close to the transmission rod 132, the contact 131 at the front end 133 of the safety device 13 will abut against a surface of a workpiece, and the safety device 13 will compress the restoring spring 14 and be moved towards the muzzle 11. However, when the transmission rod 132 abuts against the adjusting shaft 23, the transmission rod 132 will be blocked by the adjusting shaft 23 to restrict the safety device 13 from moving close to the muzzle 11, so as to limit the distance of pressing the safety device 13 downwardly towards the muzzle 11. In other words, the distance between the muzzle 11 and the surface of the workpiece is limited to achieve the effect of adjusting the nailing depth of the nailing device 10.

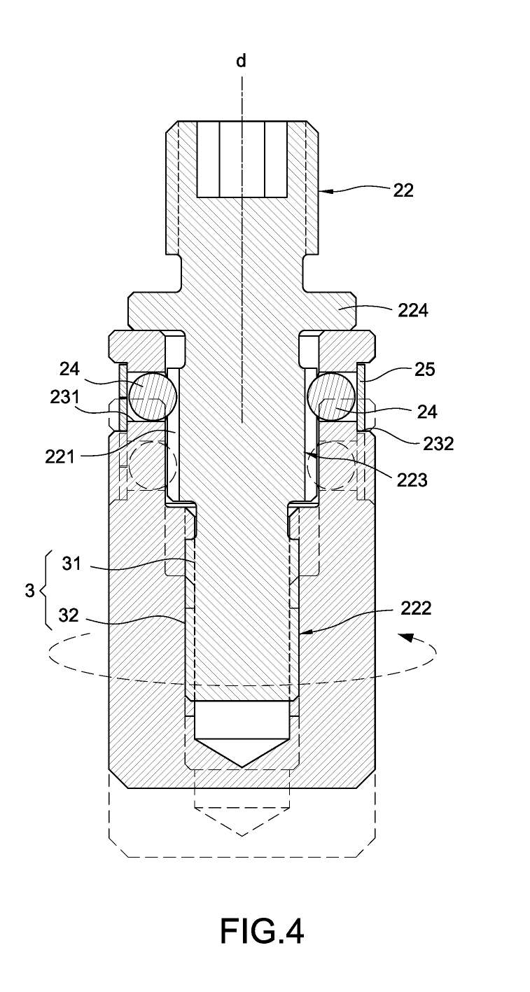

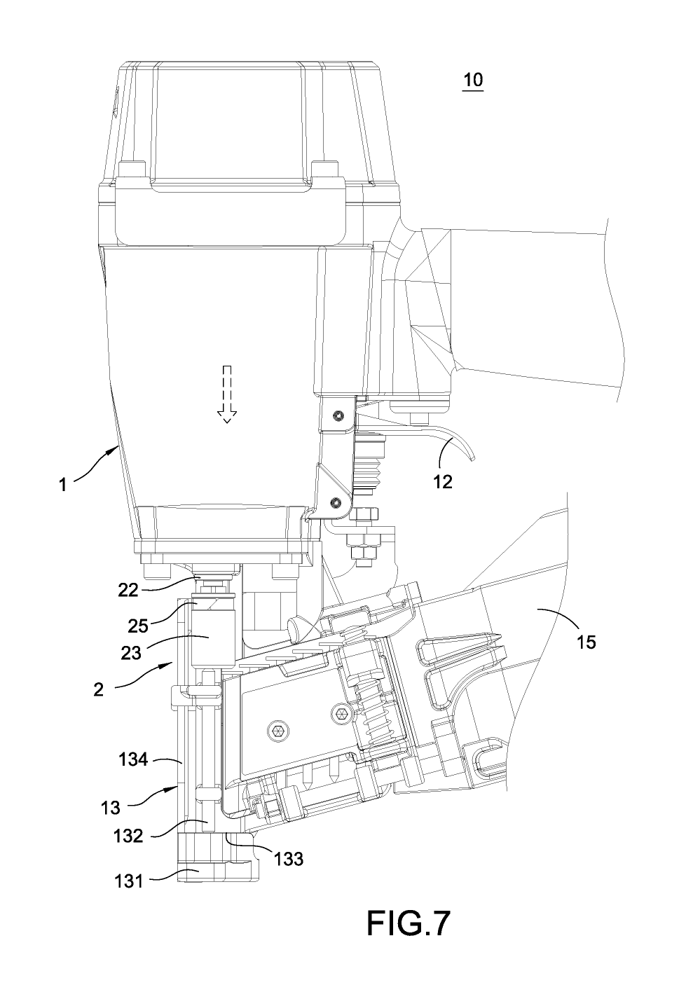

With reference to FIGS. 4 to 6 for details, the adjusting shaft 23 is not rotated nor extended to the outside with respect to the fixed rod 22, so that when the contact 131 at the front end 133 of the safety device 13 abuts against a surface of a workpiece surface, the contact 131 at the front end 133 of the safety device 13 can be pressed all the way down to the maximum depth and towards the muzzle 11. In other words, the shortest allowable distance from the safety device 13 to the muzzle 11 is achieved, so that the distance between the muzzle 11 and the surface of the workpiece surface is shortened to provide a larger nailing depth of the nailing device 10. In FIG. 7, the adjusting shaft 23 is rotated and extended outwardly with respect to the fixed rod 22 so that when the contact 131 at the front end 133 of the safety device 13 abuts against a surface of a workpiece, the contact 131 at the front end 133 of the safety device 13 can be pressed downwardly to a shorter depth towards the muzzle 11. In other words, the distance from the safety device 13 to the muzzle 11 is longer, and the distance between the muzzle 11 and the surface of the workpiece surface is larger to provide a smaller nailing depth of the nailing device 10.

Therefore, the adjustable nailing depth module 2 can achieve the effect of adjusting the nailing depth of the nailing device 10 by the simple components and structural assembly of the safety device 13, fixed rod 22 and adjusting shaft 23, and the adjustable nailing depth module 2 of this disclosure has the advantages of simple components, easy assembling, convenient operation, and low cost.

In summation of the description above, the actuating device capable of controlling the opening and closing of a clamp in accordance with this disclosure is definitely capable of achieving the expected effect and overcoming the drawbacks of the prior art, and the disclosure complies with patent application, and thus is duly filed for patent application. While this disclosure has been described by means of specific embodiments, numerous modifications and variations could be made thereto by those skilled in the art without departing from the scope and spirit of this disclosure set forth in the claims.

What is claimed is:

1. A nailing device, comprising:
a gun body, including a muzzle and a trigger;
a safety device, installed on a side of the muzzle and capable of moving with respect to the muzzle, and an end of the safety device being near the trigger for driving the trigger, and the other end of the safety device having a contact and a transmission rod extending in a direction from the contact towards the gun body and parallel to the muzzle; and an adjustable nailing depth module, comprising:
a fixed rod, together with the muzzle parallelly fixed to the gun body and extending to a length, and the fixed rod having an end section disposed at a position away from the gun body; and
an adjusting shaft, coupled to the end section of the fixed rod by a screw structure, and configured to be opposite to the transmission rod;
wherein, the adjusting shaft is capable of moving close to the transmission rod or away from the transmission rod by using the screw structure, and the safety device is blocked by the transmission rod and the adjusting shaft to restrict the distance of pressing the safety device downwardly towards the muzzle.

2. The nailing device of claim 1, wherein the safety device has a front end, and the contact is fixed to the front end.

3. The nailing device of claim 1, wherein the fixed rod has an axial line and at least a limit slot formed along the direction of the axial line, and the adjusting shaft has at least a ball pocket, and the adjustable nailing depth module further includes at least a ball, and the ball is accommodated in the ball pocket and embedded into the limit slot.

4. The nailing device of claim 3, wherein the screw structure includes an external thread formed at the outside of the end section of the fixed rod, an internal thread formed at the inside of the end section and disposed inside the adjusting shaft, and the external thread and the internal thread are screwed and coupled to one another.

5. The nailing device of claim 4, wherein the fixed rod has a middle section, and the limit slot is formed in the middle section.

6. The nailing device of claim 5, wherein the adjustable nailing depth module further comprises a collar, and the adjusting shaft has a recessed ring groove, and the ball pocket is inwardly penetrated from a bottom wall of the recessed ring groove through an inner wall of the adjusting shaft, and the collar is sheathed on and received by the recessed ring groove, and the ball is clamped between the collar and the fixed rod.

7. The nailing device of claim 5, wherein the fixed rod has a blocking ring extended between the gun body and the middle section, and the adjusting shaft is blocked and limited by the blocking ring, and a restoring spring is installed between the muzzle and the safety device.

8. An adjustable nailing depth module, used in a gun body, and the gun body having a muzzle and a safety device capable of moving reciprocally with respect to the muzzle, and the adjustable nailing depth module comprising:
a fixed rod, with the muzzle parallelly fixed to the gun body and extended to a length, and the fixed rod having an end section disposed away from the gun body; and an adjusting shaft, coupled to the end section of the fixed rod by a screw structure, and configured to be corresponsive to the safety device;
wherein, the adjusting shaft is capable of moving away from or close to the safety device by the screw structure, and the safety device is blocked by the adjusting shaft to restrict the distance of pressing the safety device downwardly towards the muzzle.

9. The adjustable nailing depth module of claim 8, further comprising at least a ball, and the fixed rod having an axial line and at least a limit slot formed in a direction along the axial line, and the adjusting shaft having at least a ball pocket, and the ball being accommodated in the ball pocket and embedded into the limit slot.

10. The adjustable nailing depth module of claim 9, wherein the screw structure includes an external thread formed on the outside of the end section of the fixed rod, an internal thread formed inside the adjusting shaft, and the external thread and the internal thread are screwed and coupled to each other.

11. The adjustable nailing depth module of claim 10, wherein the fixed rod has a middle section, and the external thread is formed in the end section, and the limit slot is formed in the middle section.

12. The adjustable nailing depth module of claim 11, further comprising a collar, and the adjusting shaft having a recessed ring groove, and the ball pocket penetrating from a bottom wall of the recessed ring groove through an inner wall of the adjusting shaft, and the collar being sheathed on and received by the recessed ring groove, and the ball being clamped between the collar and the fixed rod.

13. The adjustable nailing depth module of claim 11, wherein the fixed rod has a blocking ring extended between the gun body and the middle section, and the adjusting shaft is blocked and limited by the blocking ring.
